(19) United States
(12) Patent Application Publication
(10) Pub. No.: US 2026/0028264 A1
(43) Pub. Date: Jan. 29, 2026

(54) METHOD OF MAKING A DOPED MATERIAL AND ASSOCIATED PHOTONIC DEVICE

(71) Applicants: Raman KASHYAP, Baie d'Urfé (CA); Thomas MEYNENG, Saint-Nicolas (CA); Jyothis THOMAS, Montréal (CA); Younes MESSADDEQ, Québec (CA); Nicolas GREGOIRE, Québec (CA)

(72) Inventors: Raman KASHYAP, Baie d'Urfé (CA); Thomas MEYNENG, Saint-Nicolas (CA); Jyothis THOMAS, Montréal (CA); Younes MESSADDEQ, Québec (CA); Nicolas GREGOIRE, Québec (CA)

(21) Appl. No.: 18/998,357

(22) PCT Filed: Jul. 26, 2023
(86) PCT No.: PCT/CA2023/051004

§ 371 Date: Jan. 24, 2025

Related U.S. Application Data
(60) Provisional application No. 63/392,188, filed on Jul. 26, 2022.

(51) Int. Cl. C03B 37/018; H01S 3/094; H01S 3/16; H01S 3/23

(52) U.S. Cl. CPC C03B 37/018; H01S 3/1618; H01S 3/2308; C03B 2201/36; C03B 2203/42; H01S 3/094

(57) ABSTRACT

There is provided a photonics device including: a doped material including an oxide host hosting a system of ytterbium oxide and network modifiers, containing above 0.5×10²⁶ ions/m³ of ytterbium; a laser pump directed to the doped material; and the lifetime of an excited state of the ytterbium in response to the laser pump is of above 0.9 ms and a phonon energy of the host material is above 1000 cm⁻¹.

### CROSS REFERENCE TO A RELATED APPLICATION

This disclosure claims the priority of U.S. provisional application No. 63/392,188 filed on Jul. 26, 2023 which is incorporated herein by reference in its entirety.

### TECHNICAL FIELD

This disclosure relates to the field of ytterbium doping of oxide hosts, methods of making same and photonic devices using same.

### BACKGROUND OF THE ART

Ytterbium, a fluorescent rare earth, is used as a dopant in various types of photonic devices such as amplifiers and laser systems. Although generally increasing the concentration of ytterbium was desired for amplifiers and laser systems, the beneficial properties of ytterbium appeared to decline past a certain levels of concentration due to a phenomenon interpreted as clustering. There remains a need for increased concentrations of ytterbium as a dopant in oxide hosts, and particularly in silica.

### SUMMARY

It was found that at least in some embodiments, it was possible to increase molar concentration of ytterbium in a doped material including an oxide host hosting a system of ytterbium oxide and network modifiers, while limiting or avoiding the undesirable effects of clustering or scattering.

Accordingly, in a first aspect, there is provided a photonics device including: a doped material including an oxide host hosting a system of ytterbium oxide and network modifiers, containing an ion density of more than 0.5×10²⁶ ions per m⁻³, more than 1×10²⁶ ions per m⁻³, more than 1.75×10²⁶ ions per m⁻³, more than 2.0×10²⁶ ions m⁻³ or around 2.42×10²⁶ ions m⁻³ of ytterbium; a laser pump directed to the doped material; and the lifetime of an excited state of the ytterbium in response to the laser pump is of above 0.9 ms, above 1 ms, above 1.1 ms or above 1.2 ms, and a phonon energy of the oxide host is greater than 1000 cm⁻¹, or greater than 1500 cm⁻¹.

In some embodiments of the first aspect, a quantum efficiency of the doped material is greater than 99%.

In some embodiments of the first aspect, the oxide host is silicon dioxide, sodium borosilicate, phosphosilicate, or germanosilicate.

In some embodiments of the first aspect, the network modifiers are in solution with the oxide host.

In some embodiments of the first aspect, the network modifiers include aluminum oxide, cerium oxide, and/or phosphorous oxide.

In some embodiments of the first aspect, the phase separating agents include yttrium oxide, cerium oxide, and/or lanthanide oxide.

In some embodiments of the first aspect, the Yb concentration is of above 2.5×10²⁶ ions m⁻³.

In some embodiments of the first aspect, the photonics device is one of a power amplifier, a power laser and a laser cooler.

In a second aspect, there is provided a method of making a doped material, the method comprising, using a modified chemical vapor deposition (MCVD) technique: providing a solution doped preform containing ytterbium in the form of ytterbium chloride or ytterbium fluoride and a non-fluorescent lanthanide chloride or fluoride, drying the solution doped preform, vitrifying and collapsing the solution doped preform into a collapsed preform, heat treating the collapsed preform to induce a phase-separated state of ytterbium-rich lanthanide oxide forming a colloidal solution with an oxide host.

In some embodiments of the second aspect, in the step of providing the solution doped preform, the ytterbium is in the form of ytterbium chloride.

In some embodiments of the second aspect, the non-fluorescent lanthanide is a non-fluorescent lanthanide chloride.

In some embodiments of the second aspect, the solution doped preform contains deposited silica soot.

In some embodiments of the second aspect, the vitrifying includes converting chlorides or fluorides into oxides, respectively.

In some embodiments of the second aspect, the oxide host is a silica/aluminum oxide host.

In some embodiments of the second aspect, the heat treating is performed at a temperature gradient between 1200 and 2100° C.

In some embodiments of the second aspect, the ytterbium is in the form of ytterbium chloride 6 H₂O.

In some embodiments of the second aspect, the non-fluorescent lanthanide is yttrium eodymium, europium, terbium or praseodymium.

In some embodiments of the second aspect, the non-fluorescent lanthanide is yttrium chloride.

In some embodiments of the second aspect, the yttrium chloride is yttrium chloride 6 H₂O.

In some embodiments of the second aspect, the solution further comprises aluminum chloride.

Many further features and combinations thereof concerning the present improvements will appear to those skilled in the art following a reading of the instant disclosure.

### DESCRIPTION OF THE DRAWINGS

FIG. 1A is an absorption spectra of a ytterbium doped silica glass showing the absorption coefficient in function of the wavelength.

FIG. 1B shows the luminescence of the ytterbium doped silica glass taken while pumping using a 1030 nm laser.

FIG. 1C is a graph of the change in temperature (cooling) in function of time with the laser ON then OFF (7 W).

FIG. 1D is a graph showing the change in temperature in function of time with the laser ON then OFF (6 W).

FIG. 2A is a graph showing the atomic fraction in function of the length of the particles, measured by electron-probe micro-analysis.

FIG. 2B is a scanning electron microscopy image (SEM) of a phase-separate core of a doped silica glass.

FIG. 3A is schematic showing a low Yb concentration Yb/Si system.

FIG. 3B is a schematic showing a high Yb concentration Yb/Si system.

FIG. 3C is a schematic showing the use of a passive rare-earth element to dissolve the active rare-earth in the phase separation of Yb/Si system.

FIG. 4A is an image of the temperature gradient showing 5 zones, zone 1=1200° C., zone 2=1400° C., zone 3=1550° C., zone 4=1700° C., and zone 5>1900° C.

FIG. 4B is a microscopy image of the doped material in zone 1.

FIG. 4C is a microscopy image of the doped material in zone 2.

FIG. 4D is a microscopy image of the doped material in zone 3.

FIG. 4E is a microscopy image of the doped material in zone 4.

FIG. 4F is a microscopy image of the doped material in zone 5.

FIG. 5 is a graph of the resistance frequency in function of particle diameter for each of zones 1-5.

FIG. 6 is a graph showing the mean particle diameters (●) and the particles surface fraction (▪) for each of zones 1-5 (labeled as pos 1-5).

FIG. 7A is a microscopy image of a doped material obtained with a yttrium+ytterbium solution doping.

FIG. 7B is a microscopy image of a doped material obtained with a yttrium+aluminum+ytterbium solution doping.

FIG. 7C is a close up of the region identified by a rectangle in FIG. 7B.

FIG. 7D is a is a microscopy image of a doped material obtained with a yttrium+barium+ytterbium solution doping.

FIG. 7E is a close up of the region identified by a rectangle in FIG. 7D.

### DETAILED DESCRIPTION

In one embodiment, enhancing the concentration of rare earth ions in high phonon energy glasses can be achieved without the effects of clustering or scattering, leading to high fluorescence yield approaching 100% and long upper state lifetimes. Using a sacrificial rare earth element such as yttrium, it is shown herein that the concentration of Yb in silica preforms can be increased without clustering or nucleation into scattering crystals. When using the method of the present disclosure, an improved laser cooling in Yb doped silica preforms was obtained. A photonics device can therefore be created such as a high power laser, high power amplifier, a laser cooler, a radiation balanced laser, and a laser for cooling in mouldable glass. The photonics device can contain a doped material including an oxide host hosting a system of ytterbium oxide and network modifiers as well as a laser pump. The doped material achieves an increase in the concentration of ytterbium. In some embodiments, the Yb concentration is of above 0.5×10²⁶ ions/m³, above 1×10²⁶, above 1.75×10²⁶ ions per m⁻³, above 2.0×10²⁶, or around 2.5×10²⁶. In some embodiments, the lifetime of an excited state of the ytterbium in response to the laser pump is of above 0.9 ms, above 1 ms, above 1.1 ms or above 1.2 ms. In some embodiments, a phonon energy of the oxide host is greater than 1000 cm⁻¹ or than 1500 cm⁻¹. In some embodiments, ytterbium is present in a concentration of above 0.2 molar %, above 0.3 molar % or around 0.4 molar %. The doped material is advantageously easy to fabricate and re-work in order to maintain or obtain the required properties for a desired application. The quantum efficiency of the doped material can be greater than 99%. Examples of oxide hosts include but are not limited to silica-based materials such as silicon dioxide, silica, borosilicates, germanosilicates and phosphosilicates. The network modifiers can be in solution with the silica to form the host. In some cases, the network modifiers include aluminum oxide, cerium oxide, phosphorous oxide, or barium oxide. Phase separating agents such as yttrium oxide, cerium oxide, and otherlanthanide oxides, preferably yttrium oxide may be added to modify the local phase separated environment. Additional examples of lanthanides include but are not limited to eodymium, europium, terbium, praseodymium.

Increasing the concentration of ytterbium, a fluorescent rare earth used as a dopant, past a certain level in a silica based oxide host, can lead to clustering, which limited the potential of use of such systems in photonics applications such as high power amplifiers, high power lasers, or laser cooling. Indeed, clustering can be witnessed by a diminution quantum efficiency (e.g. below 99%) or the lifetime of the excited state of ytterbium oxide were reduced, an indication that clustering had occurred.

In one embodiment, the present doped material achieves a density of ytterbium above 10²⁶ ions m⁻³ (and even up to or above 2.4×10²⁶ ions m⁻³), while avoiding clustering or lifetime shortening.

It is believed that the combined use of yttrium and heat treating, post vitrification and collapsing, generates a structure which protects the ytterbium from clustering. This phenomenon may proceed via chloride precursor rather than fluoride precursor which also has a role in making this work.

Accordingly, in one aspect, there is provided a method of making a doped material using a modified chemical vapor deposition (MCVD) technique. A solution doped preform containing ytterbium in the form of ytterbium chloride or ytterbium fluoride and a non-fluorescent lanthanide chloride or fluoride is provided. The solution doped preform can contain deposited silica soot. Ytterbium chloride and non-fluorescent lanthanide chloride are preferably selected. The solution doped preform is subjecting to drying, vitrifying and collapsing the solution doped preform into a collapsed preform. The vitrifying preferably includes converting chlorides or fluorides into oxides, respectively. The collapsed preform is heat treated (e.g. temperature gradient between 1200 and 1900° C.) to induce a phase-separated state of ytterbium-rich lanthanide oxide forming a colloidal solution with an oxide host. In some embodiments, the oxide host is a silica/aluminum oxide host. In some embodiments, the ytterbium is in the form of ytterbium chloride 6 H₂O. In such embodiments, the solution can further contain yttrium chloride 6 H₂O, and aluminum chloride 6 H₂O.

For efficient cooling, it is important to choose a rare earth (RE) ion and host composition that offers a near-unity quantum efficiency along with reducing the background absorption. Along with the purity, optimizing the composition as well as the RE ion density is helpful in order to maximize the quantum yield that will ultimately set the optical performance limits of glasses for cooling applications.

In one embodiment, a composition of ytterbium doped silica glass (GAYY—Aluminum-Yttrium-Ytterbium system) was fabricated using a modified chemical vapor deposition (MCVD) technique. Its improved performance was demonstrated by comparing a phase separated ytterbium sample with that of normal preform (see Examples 1, 2 and 3 below). The cooling in the highest concentration of Yb in silica fibre of 2.42×10²⁶ ions/m³. No clustering or lifetime shortening was observed. The temperature-dependent spectroscopic data, including absorption and emission cross-sections, photoluminescence emission, fluorescence lifetime, etc., which are essential material properties indicating potential for laser cooling for applications were also measured. The presently described ytterbium doped materials are improved materials not only for high-efficiency laser cooling, but also for super-high-power fibre lasers as well.

Indeed, silica-based glasses and optical fibers are important for the development and fabrication of solid-state laser cooling based on anti-Stokes fluorescence. For example, silica-based glasses are used in the technological development of radiation balanced lasers, fiber amplifiers, optical cryocoolers and the like. Although solid-state laser cooling was posited nearly a century ago, the enormous interest in optical properties of glasses and optical fibers arose relatively recently with the observation of laser cooling in ZBLAN glasses. Improvements in silica-based glasses for their application in laser cooling, for example, is therefore desired.

### Example 1

### Materials and Methods

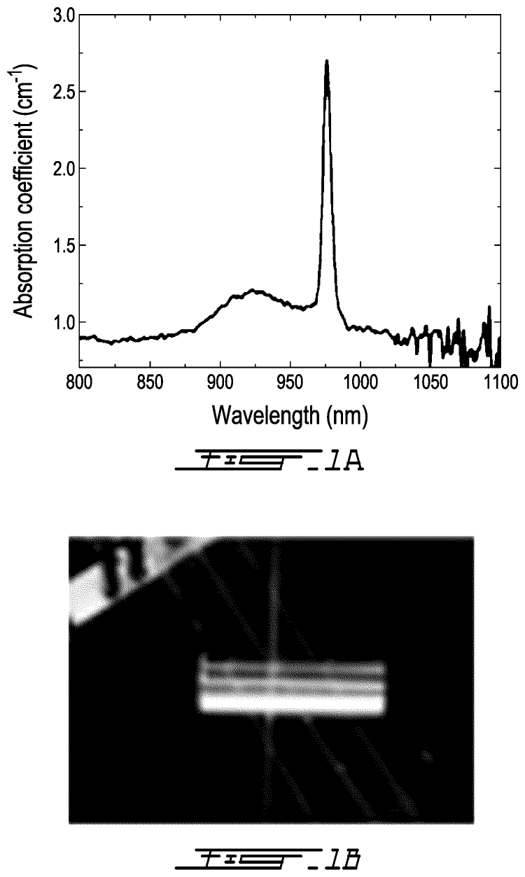

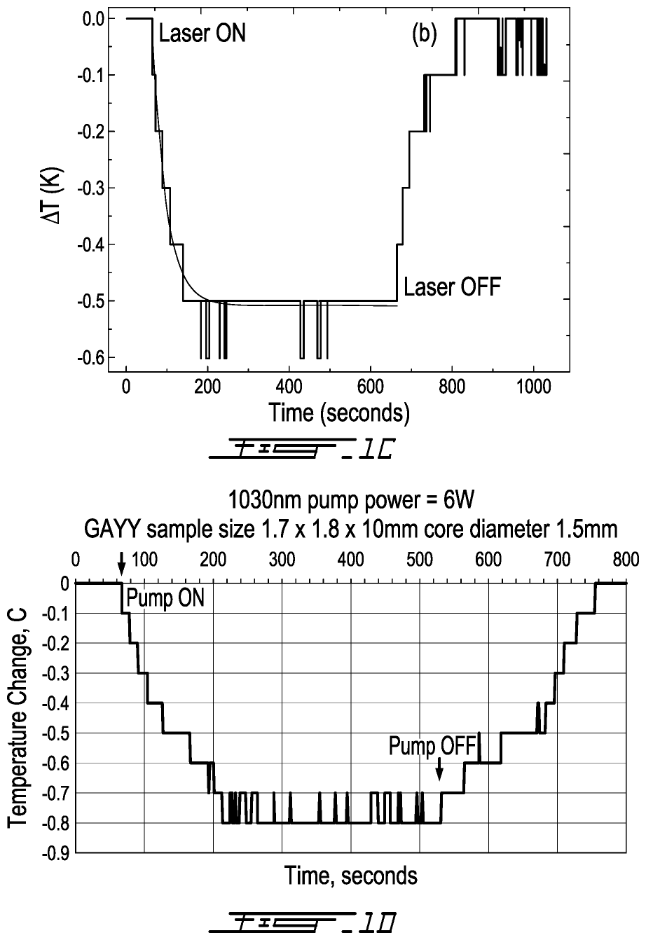

The high purity GAYY glass (2 mm×2 mm×10 mm) was fabricated using modified chemical vapor deposition method (MCVD). The doped region had a 1.6 mm diameter in the centre. A pump power 7 W at 1030 nm was used. The temperature was dropped from room temperature (line with laser ON and OFF, FIG. 1A). A fitted exponential drop (smaller thickness line, FIG. 1A) was determined. The time constant was 31 s. The ytterbium doped core was about 1.5 mm in diameter. The microstructural analysis of the preform was performed using scanning electron microscopy (SEM) analysis. The quantum yield of the preform was obtained using an integrating sphere method. The background absorption measurements were made using fiber Bragg grating (FBG) direct contact method using a laser operating at 1550 nm. The same FBG was used to measure the temperature change while exciting the sample with a 1030 nm laser (606 kHz repetition rate, 4 ps pulse duration) with the pump power varying from 1 W to 7 W.

The cooling of ytterbium doped silica glass was demonstrated to −0.6 K from room temperature at atmospheric pressure and temperature with only 7 W of pump power at a wavelength of 1030 nm laser. It is presently reported that cooling in the highest concentration of Yb ions (a ˜5× improvement) was achieved with little or no degradation in lifetime or quantum efficiency, compared to the best results previously reported in the literature. The glass was systematically analyzed for structural and optical properties through SEM, absorption and fluorescence spectral measurements. The lifetime and quantum yield performance of GAYY glass compared to the normal preform benefits significantly from phase separation in the present composition.

The present simple approach for producing high concentration Yb doped silica glass open with excellent thermal, mechanical and optical properties, opens possibilities for the development of the next generation laser coolers and high-power lasers, including fiber lasers and amplifiers.

### Results and Discussion

The measured photoluminescence (PL) emission for the GAYY was significantly enhanced in the phase separated Yb glass (QE=99%) compared with the normal preform (QE=78%), benefitting from the local rare-earth environment. The GAYY glass possessed a longer lifetime (1.2 ms) compared with the normal preform without phase separation (0.93 ms). These unique and important results are due to phase separation and the presently unique material composition. The Yb³⁺ ion possessed a broad absorption band (FIG. 1A) varying from 870 to 1050 nm, which can be attributed to the ground (2F_{7/2}) and excited (2F_{5/2}) stark sublevel electronic transitions. The structural characterization by SEM showed strong phase separation of the rare earth in the GAYY preform.

In order to assess the cooling potential of GAYY glass, the sample was pumped using a 1030 nm laser (FIG. 1B). Since this pump's wavelength was higher than that of the mean fluorescence wavelength (˜1021 nm), a net heat extraction was obtained. A maximum temperature reduction of 0.5 K from room temperature (RT) was achieved using only 7 W of pump power (FIG. 1C). However, the normal preform sample heated to 0.4 K using a pump power of 1 W. This is a surprising result because the GAYY glass demonstrated such a dramatic difference compared to the normal preform while pumping with 1030 nm laser. This observation demonstrates the capability of using the obtained glass in high efficiency solid-state laser cooling systems, ultra-high-power fiber lasers, heat balanced laser systems, satellite instrumentation and sensors. The experiment was repeated with a 6 W pump (1030 nm pump power) with a GAYY sample size of 1.7×1.8×10 mm having a core diameter of 1.5 mm (FIG. 1D).

### Example 2

A F300 grade Heraeus silica tube was placed inside of a MCVD system. After cleaning and drying steps, SiCl₄ and He/O₂ gas were flowed through the tube. The tube was locally heated to 1325° C. with a H₂/O₂ burner in order to oxidize the silicon tetrachloride into a SiO₂ soot. The flame was moved along the tube to create a first layer of SiO₂ on the inner walls of the tube. This step was then repeated two more times with an increase of 15° C.

In order to obtain the solution leading to the GAYY samples the following process was applied to prepare the solution. In a 300 mL clean Teflon beaker, the following precursors were added with associated mass:
yttrium chloride hexahydrate (6N purity Rare-earth oxide and transition metals): 22.29 g,
aluminum chloride hexahydrate (6N purity Rare-earth oxide and transition metals): 30.18 g, and
ytterbium chloride hexahydrate (6N purity Rare-earth oxide and transition metals): 2.58 g.

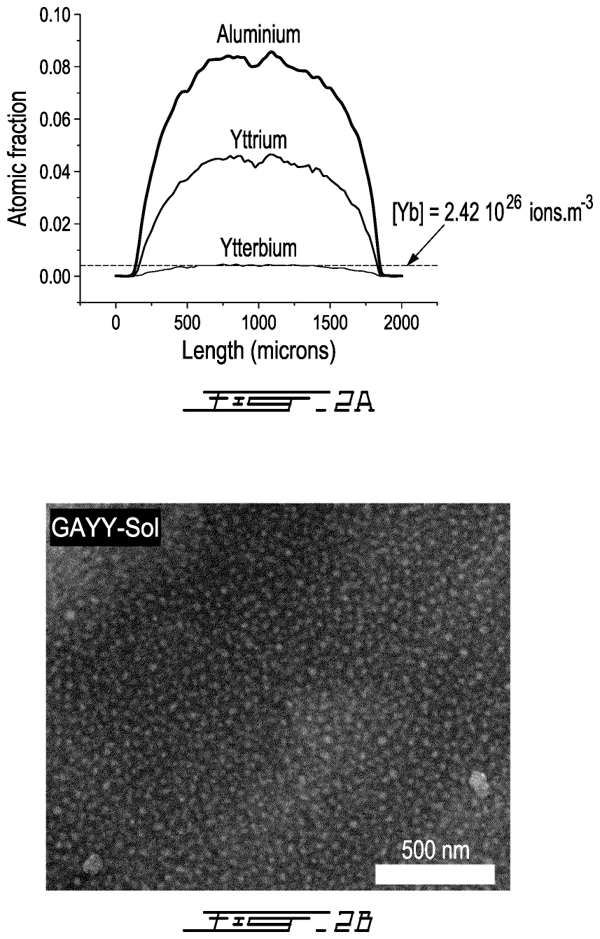

The following composition of preform core was obtained from this recipe, leading to a max Yb density of 2.42×10²⁶ ions per m³ as shown in FIG. 2A.

Ultra-pure Millipore grade water (18.04 mOhms) water was added to fill the solution to 250 mL. A clean Teflon agitator was added, and the solution was stirred up to complete dissolution of the chlorides. A cover plate was also added to prevent dusts particles from touching solution.

Once the solution was ready, the silica tube was place in a vertical position and the solution was slowly incorporated using the communicating vessel (vase communicants) setup. Once the tube was full, the solution was evacuated and retrieved. The top of the tube was then connected to a dry nitrogen gas line and a 2 L/seconds flow was passed through overnight to dry the doped soot. The next day the tube was placed on the MCVD system and the tube was heated by a moving flame, doing 21 passes from 800 to 1500° C., under nitrogen flow to fully dehydrate the soot. Sintering and vitrification of the soot was realized at 1600° C. for one pass followed by a 2100° C. pass. Collapse of the preform was done at 2100 to 2200° C. The final preform was then fire polished at 2000° C. SEM of the phase separated core is shown in FIG. 2B.

### Example 3

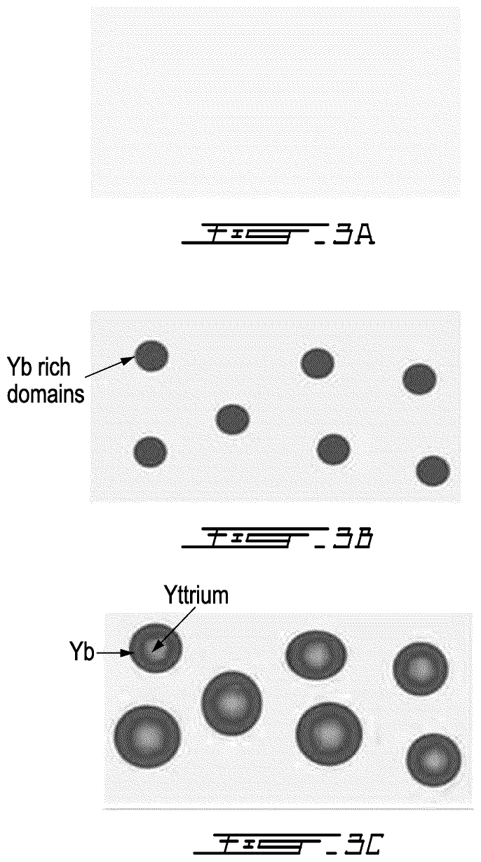

FIG. 3A shows a low Yb concentration Yb/Si system with good homogeneity, low photoluminescence (PL) intensity and no cooperative relaxation. FIG. 3B shows a high concentration Yb/Si system with phase separation, low PL intensity and strong cooperative relaxation. FIG. 3C shows the use of a passive rare-earth to dissolve the active rare-earth in the phase separation resulting in a high PL intensity, lower cooperative relaxation and lower phonon energy. When yttrium is at the edge of lanthanides, no phosphorescence is exhibited. When ytterbium congregates outside yttrium the particles can grow.

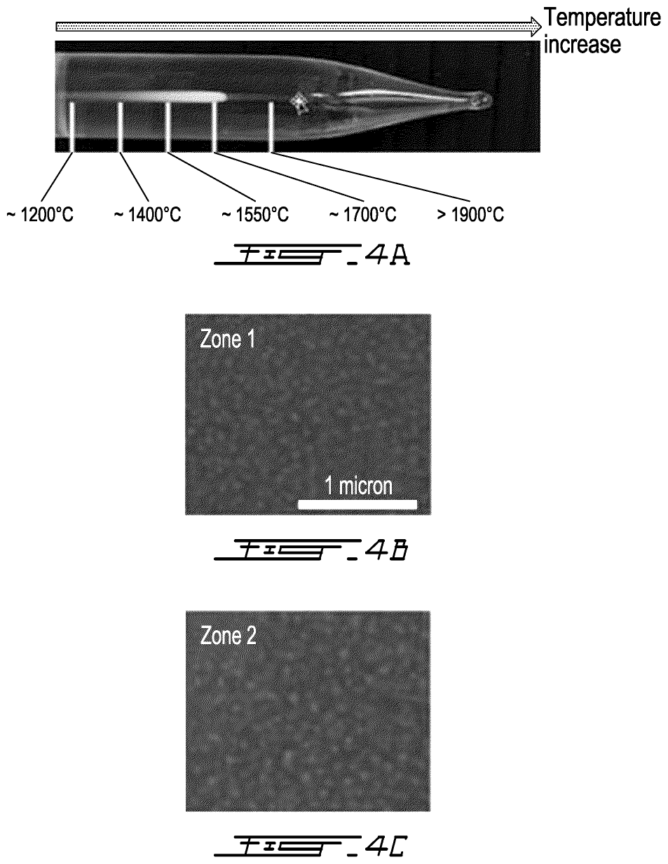

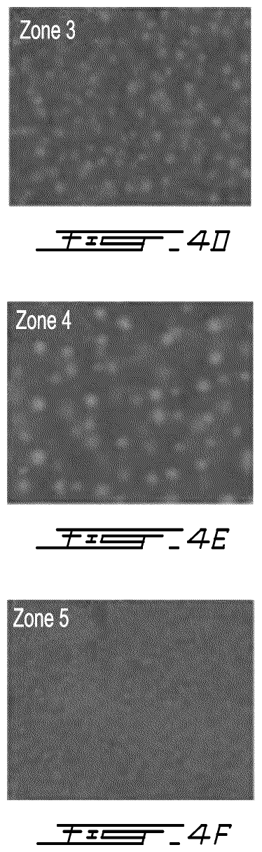

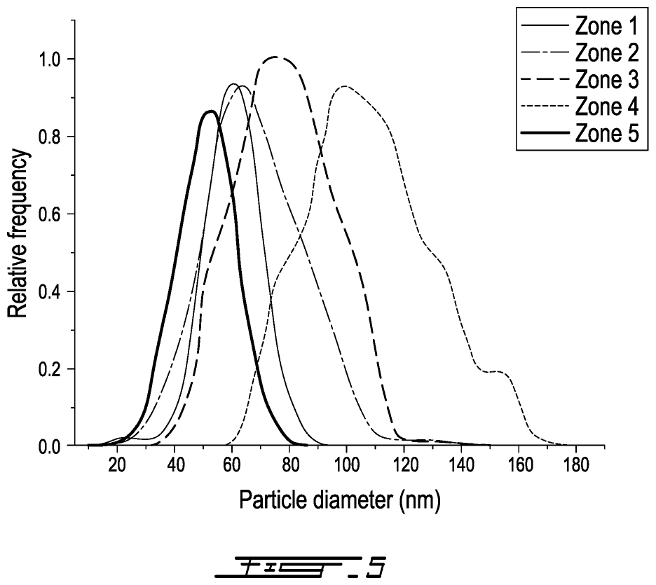

Barium, yttrium and ytterbium were subjected to a temperature gradient (zones 1-5) over a short time period as shown in FIG. 4A. The resulting microscopy images across the temperature gradient as shown in FIGS. 4B-4F. As can be seen from the microscopy images a progressive phase separation scale up to 1900° C. (zone 5) was obtained. The relative frequency was quantified (shown in FIG. 5) and the mean particle diameters and particle surface fractions were also quantified (shown in FIG. 6).

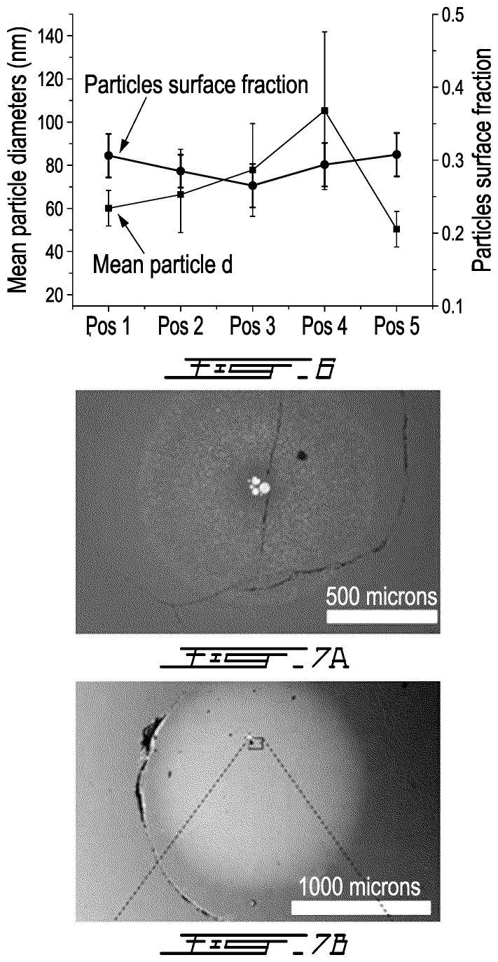

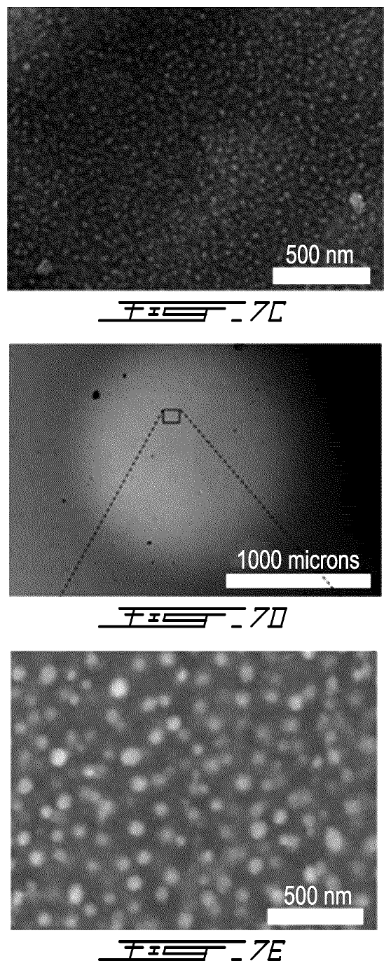

Different combination of solution doping were tested: yttrium+ytterbium, yttrium+aluminum+ytterbium, and yttrium+barium+ytterbium. The results are shown respectively in FIGS. 7A, 7B-7C, and 7D-7E. The addition of the network modifiers moved the phase separation from a micrometric to nanometric scale thereby strongly reducing scattering. Aluminum demonstrated the best performance. It is preferred to avoid yttrium and ytterbium from interacting close by to aluminum, in order to allow to separate yttrium from ytterbium. A 15-20 times ytterbium concentration in the little dots was achieved demonstrating the nanostructuring of the glass. It is demonstrated herein that a local environment for ytterbium was achieved, which allows other rare earths to see a different environment and react differently.

It is noted that other rare earths dopants can be used and other rare glasses as well. Soft glasses, or crystals are preferred as alternatives are generally difficult to manipulate or mould in a desired shape.

1. A photonics device comprising:
a doped material including an oxide host hosting a system of ytterbium oxide and network modifiers, containing an ion density of more than 0.5×10²⁶ ions per m⁻³ of ytterbium;
a laser pump directed to the doped material;
wherein the lifetime of an excited state of the ytterbium in response to the laser pump is of above 0.9 ms, and a phonon energy of the host material is higher than 1000 cm⁻¹.

2. The photonics device of claim 1, wherein a quantum efficiency of the doped material is greater than 99%.

3. The photonics device of claim 1, the oxide host is silicon dioxide, sodium borosilicate, phosphosilicate, or germanosilicate.

4. The photonics device of claim 3, wherein the network modifiers are in solution with the oxide host.

5. The photonics device of claim 1, wherein the network modifiers include aluminum oxide, cerium oxide, and/or phosphorous oxide.

6. The photonics device of claim 1, wherein the phase separating agents include yttrium oxide, cerium oxide, and/or lanthanide oxide.

7. The photonics device of claim 1, wherein the Yb concentration is of above 2.5×10²⁶ ions m⁻³.

8. The photonics device of claim 1, wherein the photonics device is one of a power amplifier, a power laser and a laser cooler.

9. A method of making a doped material, the method comprising, using a modified chemical vapor deposition (MCVD) technique:
providing a solution doped preform containing ytterbium in the form of ytterbium chloride or ytterbium fluoride and a non-fluorescent lanthanide chloride or fluoride,
drying the solution doped preform, vitrifying and collapsing the solution doped preform into a collapsed preform,
heat treating the collapsed preform to control the amplitude of phase-separated state of ytterbium-rich lanthanide oxide forming a colloidal solution with an oxide host.

10. The method of claim 9, wherein in the step of providing the solution doped preform, the ytterbium is in the form of ytterbium chloride.

11. The method of claim 10, wherein the non-fluorescent lanthanide is a non-fluorescent lanthanide chloride.

12. The method of claim 9, wherein the solution doped preform contains deposited silica soot.

13. The method of claim 9, wherein the vitrifying includes converting chlorides or fluorides into oxides, respectively.

14. The method of claim 9, The method of any one of claims 9 to 13, wherein the oxide host is a silica/aluminum oxide host.

15. The method of claim 9, wherein the heat treating is performed at a temperature gradient between 1200 and 2100° C.

16. The method of claim 9, wherein the ytterbium is in the form of ytterbium chloride 6 H₂O.

17. The method of claim 9, wherein the non-fluorescent lanthanide is yttrium eodymium, europium, terbium or praseodymium.

18. The method of claim 9, wherein the non-fluorescent lanthanide is yttrium chloride.

19. The method of claim 18, wherein the yttrium chloride is yttrium chloride 6 H₂O.

20. The method of claim 9, wherein the solution further comprises aluminum chloride.
